(19) United States
(12) Patent Application Publication
(10) Pub. No.: US 2019/0257465 A1
(43) Pub. Date: Aug. 22, 2019

(54) CANISTER STAND

(71) Applicant: WILLIAMS COMPANY ENTERPRISES, LLC, Springfield, MO (US)

(72) Inventor: RICK WILLIAMS, SPRINGFIELD, MO (US)

(21) Appl. No.: 16/281,913

(22) Filed: Feb. 21, 2019

Related U.S. Application Data
(60) Provisional application No. 62/633,658, filed on Feb. 22, 2018.

(51) Int. Cl. F16M 11/22; F16M 11/04

(52) U.S. Cl. CPC F16M 11/22; F16M 2200/08; F16M 11/041

(57) ABSTRACT

A canister stand is described for holding a canister containing a solution in an upright position while the contents of the canister are dispersed through a nozzle provided on the canister. The canister stand may be stored in a flat, storage configuration and deployed to provide stability to a canister as desired. The canister stand is provided with an opening provided with retaining tabs and base supports disposed around the edges of the stand.

### CROSS-REFERENCE TO RELATED APPLICATIONS

This application claims the benefit of U.S. Provisional Patent Application Ser. No. 62/633,658 filed on Feb. 22, 2018, the disclosure of which is incorporated herein by reference.

### BACKGROUND

The canister stand is in the field of stands or supports for pressurized canisters or other similar items that need to be held in an upright position during use. More specifically, the canister stand is in the field of devices to prevent canisters from tipping over during use. The canister stand may be used to support a canister an upright position in a moving vehicle, such as an enclosed trailer.

### SUMMARY OF THE INVENTION

The inventive canister stand claimed herein may be provided in various embodiments. In one embodiment, the stand consists of a substantially planar base, at least one base support disposed at the edge of the base, an opening for receiving the canister disposed in the base, and a canister holder for retaining the canister in the opening. In some embodiments, the base supports may not be at the edge of the base, but at some portion of the base that is spaced apart from the canister opening.

In some embodiments, the base support is attached to the base by a hinged attachment or mechanism that permits the base support to pivot from a flat, storage position to a downward, deployed position. In the downward, deployed position the base support supports the base 102 above a surface on which the canister is to be placed during dispersal. In some embodiments of the canister stand, the base supports comprise tabs provided in the base capable of being bent downwardly from the base.

In some embodiments of the canister stand, the canister holder comprises one or more retaining tabs for retaining the canister in the opening. In some embodiments of the canister stand, the retaining tabs are attached to the edge of the opening by a hinged attachment that allows the retaining tabs to pivot from a flat storage position to an upward, deployed position.

In some embodiments of the canister stand, a canister is inserted into the opening in the base of the stand and is retained there by the retaining tabs. The base supports are deployed to contact the surface on which the stand and canister are placed during use.

### BRIEF DESCRIPTION OF THE DRAWINGS

FIG. 1 is a perspective view of an embodiment of the canister stand.

FIG. 2 is a perspective view of an embodiment of the canister stand in a deployed configuration.

FIG. 3 is a top plan view of an embodiment of the canister stand.

FIG. 4 is a cross-sectional view of an embodiment of the canister stand.

### DETAILED DESCRIPTION

Pressurized canisters that contain a useful solution, such as disinfectant, insecticide, or other similar compositions, are well known for household and commercial use. In many such canisters a propellant is provided in the canister with the solution. Upon activation of a valve that is provided on the canister, the propellant forces the solution out through a nozzle that causes the solution to form an aerosol such as airborne mist, a fog, or a spray. This mist, fog, or spray efficiently disperses the solution throughout the area in which the canister is being used, thus providing effective treatment of germs, bacteria, viruses, insects, or other similar undesirable conditions. The type, selection, or design of the propellant or the solution is not limiting of the inventive canister stand. Similarly, the cross-sectional shape or relative dimensions of the canister itself are not limiting of the inventive canister stand, and varying embodiments of the canister stand may be designed to fit varying shapes and sizes of canisters.

In many cases the canisters are cylindrical and are set on the second, base end of the cylinder, with the valve and nozzle provided on a first end of the cylinder, and are during use so that the fog or mist of solution is sprayed upwardly for optimal dispersion. These devices are used in commercial or residential buildings, but are also used in other types of enclosed spaces that need to be sanitized or otherwise treated with solutions suited for dispersion as an aerosol. Such enclosed spaces include the interior of vehicles, cargo trailers, railroad cars, shipping containers, box trucks, and similar types of enclosed spaces that may are capable of moving from place to place, either on their own or from towing by a motorized vehicle.

Often the canister has a length or height that is substantially greater than the diameter of the circular aspect of the cylinder, thereby creating a situation in which the canister is easily tipped onto its side during dispersal of its contents. A canister that is disposed on its side during dispersion of its contents is likely to result in inadequate dispersal of the solution from the canister. In some cases, this inadequate dispersal is due to the non-vertical dispersion that occurs once the canister is on its side, since the aerosol that is dispersed in this configuration may contact the surface on which the canister is located and never reach the entire volume of the room or area of intended dispersal. Additionally, if the nozzle is located on one end of the cylinder, many canisters will not dispense all, or even most, of the solution if the canister is on its side because the liquid in the canister will flow into and prevent proper operation of the nozzle or valve.

In some applications, such as disinfecting a the cargo area of a cargo trailer, such as the type used with a tractor-trailer combination, the canister is placed in the cargo area, activated and then while the solution is being dispersed, the cargo trailer is pulled or moved. In this situation, the canister becomes much more likely to tip over due to movement encountered by the cargo trailer as it is pulled along the road. The cylindrical shape of most canisters is then susceptible to rolling around the cargo area of the cargo trailer, leading to uneven and ineffective dispersal of the solution. Similarly, the same problems arise when using a pressurized canister to treat the interior of a cargo or box truck, a railroad car, or shipping containers, or any other space that may be moved while the canister is dispensing its contents.

A canister stand is described for providing added stability to a canister while it is being used to dispense a solution in situations such as those described above. In this embodiment, the canister stand has a flat storage configuration to allow for convenient storage when not in use. The stand provides added stability to the canister and holds the canister in the desired upright position during dispersal of the contents of the canister, even when the canister is being used in an enclosed structure that is in motion. The canister stand may be included as a component of a system along with canisters of cleaning, disinfecting, insecticidal, or exterminating products.

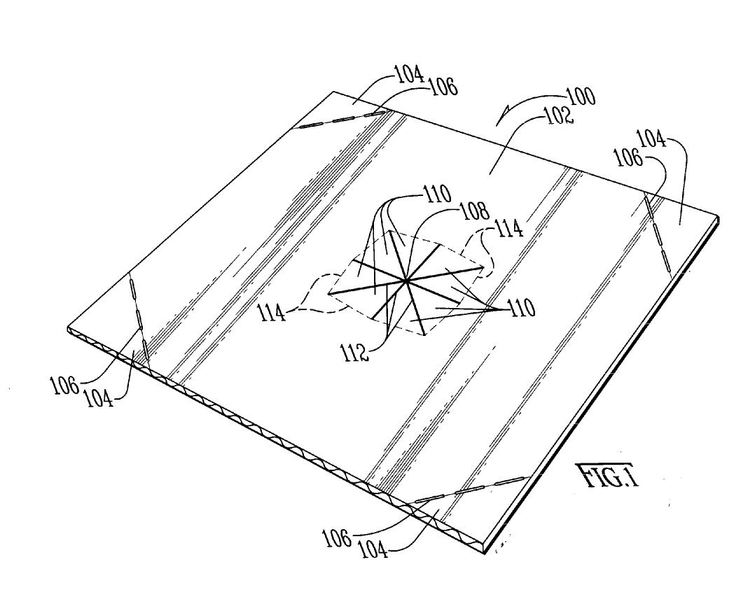

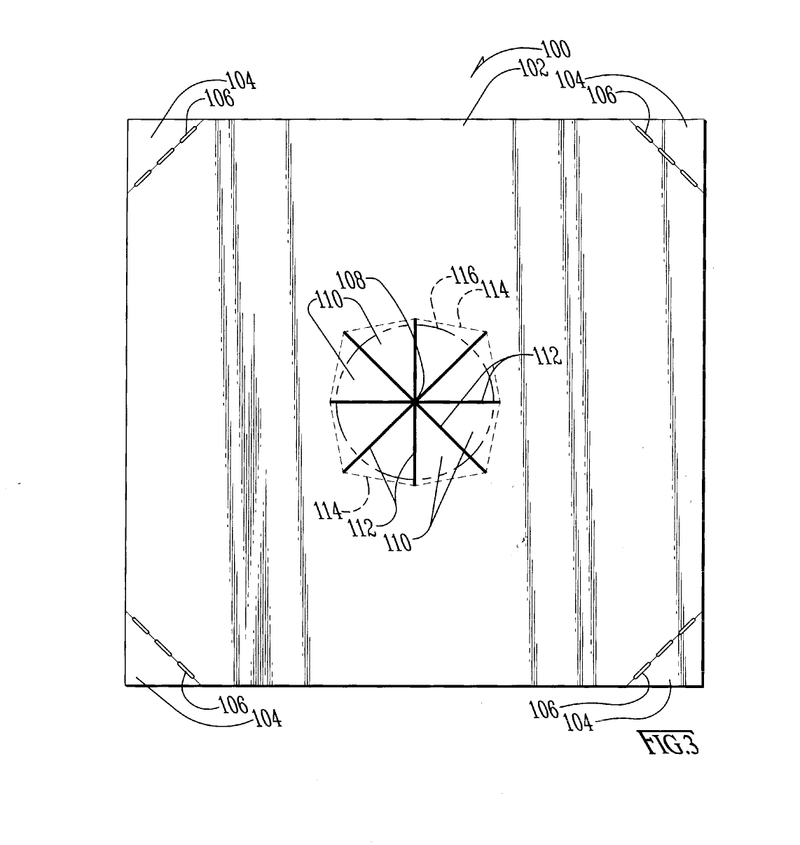

Referring now to FIGS. 1 and 3, a perspective view and a top plan view, respectively, of an embodiment of the canister stand 100 are depicted in a flat, storage configuration. The storage configuration of the stand 100 provides a flat aspect that is optimal for packaging the stand 100 with other components of a system as described above, or storing it when not in use. The stand 100 comprises a base element 102 formed from a sheet of an appropriate material. In various embodiments, the base element 102 may be formed from corrugated paper board, cardboard, plastic, foam, metal, or any other material that is capable of providing a semi-rigid element. The thickness of the base 102 may vary depending on the rigidity of the material selected to form the base, the size of the canister with which the base will be used, and type of application in which the stand 100 will be used. While the preferred embodiment of the base 102 is a flat aspect, in some embodiments, all or a portion of the base 102 may be curved, domed, or otherwise non-planar in aspect in one or more direction.

In the depicted embodiment of the stand 100, the shape of the base 102 when viewed from above is substantially square, or slightly octagonal. In other embodiments, the base 102 may be rectangular, triangular, or various other polygonal shapes, or even oval or circular in some embodiments. The shape of the base is defined by the outer edges of the base.

In some embodiments of the stand, the base 102 may be formed from a flat sheet of material that can be folded or assembled into a spherical, hemispherical, frustoconical, frustopyramidal, or other similar shape prior to use as a canister stand. In the example of a spherical device, the canister would be installed off center so that when the sphere rolled its center of gravity would return it to a position with the nozzle on the canister pointed upwards for proper dispersal of the contents of the canister. In the example of frustoconical or frustopyramidal embodiments of the canister stand, the base 102 may fold into a cone or pyramid whose point is truncated by the opening 108 for a canister, and all or a portion of whose outer edges form the base supports that contact the surface supporting the canister.

Portions of the base 102 identified as base supports 104 are provided for additional support when disposed in a downward position. When folded or bent into the downward position, the base supports 104 serve as support legs that contact the surface upon which the stand 100 is being used to support a canister. Multiple, dispersed points of contact with the surface provide added stability to hold the canister in an upright position.

In various embodiments of the stand 100, the base supports 104 may be provided at corners of the base 102, such as shown in the figures, or along the edges of the base 102 such as in embodiments that are circular, oval, or don't have well-defined corners. In some embodiments, the stand 100 may be provided with a varying number of base supports 104 other than the four tab embodiment shown in the figures. Many embodiments of the stand 100 are provided with at least three base supports 104 to provide three points of contact when the stand 100 is in use to support a canister. In some embodiments there may be only one or two base supports 104 which may be used in conjunction with other parts of the edge of base 102 to provide the necessary multiple points of contact.

The base 102 is provided with base supports 104 at multiple locations around the edge of base 102. The base supports 104 may be folded, bent, or locked into a downward or deployed configuration to provide support to the base 102 when it is in use to support a canister. In some embodiments the base supports 104 may be provided with tabs or notches to interlock with other parts of the base 102 to lock them into the downward position.

The base supports 104 are attached to the base 102 by a seam, hinge, or other foldable connection 106 that allows each base support 104 to be pivoted to a downward position and maintained there during use of the stand 100. In the depicted embodiment the seam or hinged connection is a series of perforations through the corrugated paper material comprising base 102 that allow the base supports 104 to be folded to the downward position. The foldable connection 106 is preferred to be formed so that the base support 104 will tend to stay at whatever angle it is placed with respect to the base 102, unless a user applies force to the base support 104 to pivot it to another angle.

In the depicted embodiments the base supports 104 are disposed on the edge of base 102. In other embodiments the base supports may be part of base 102 that is not at the edge of base 102. For example a portion of base 102 disposed away from the edge of the base may be cut in an L or triangle shape to create a base support that may be folded downwardly to support the base.

In some embodiments, the base supports 104 may be provided with an additional joint to increase the contact between the base support 104 and the supporting surface. For example, a second hinge may be provided across a base support 104 such that it can be folded back in the opposite direction from the first hinge to form a “foot” area of the base support 104 that may increase the area of contact between the base support 104 and the surface.

The base 102 is also provided with a canister opening 108 through the interior of the base 102 for receiving a canister. The canister opening may vary in size and shape to accommodate a variety of canister sizes and shapes. In varying embodiments, the canister opening is provided with a canister holder for retaining the canister in the opening during use. In some embodiments of the canister stand, the canister holder comprises one or more retaining tabs 110 for holding the canister in the opening 108 in a desired position during use.

In the depicted embodiment, the opening 108 is created by cutting a plurality of slits to form the tabs 110 at the desired location for the opening 108. Folding the tabs 110 into an upward position creates the opening 108 and also provides the retaining tabs 110 to engage a canister. In the depicted embodiment four slits 112 are cut through base 102. The slits intersect at their approximate mid-points and are oriented at 45 degrees to the adjacent slits 112. In other embodiments of the stand 100 there may be only two slits disposed at 90 degrees to one another. In other embodiments the slits may be disposed such that the adjacent angles formed by the slits are different angles. In other embodiments, other configurations of tabs may be used with different shapes and additional separation between the tabs.

In other embodiments, the opening 108 may be formed into a desired shape by cutting an outline of an aperture of the opening 108, with retaining tabs 110 provided in or adjacent to the opening that cover less then all of the opening 108 when in the flat, storage position. The opening is defined by the interior edges of the base surrounding the aperture.

The retaining tabs 110 are attached to the base 102 by a seam, hinge, or other foldable connection 114 that allows each retaining tab 110 to be pivoted to an upward or downward position in the deployed configuration and maintained there during use of the stand 100. In the depicted embodiment the seam or hinged connection is a series of perforations through the corrugated paper material comprising base 102 that allow the retaining tabs 110 to be folded to an upward position. The foldable connection 114 is preferred to be formed so that the retaining tab 110 will tend to stay at whatever angle it is placed with respect to the base 102, unless a user applies force to the retaining tab 110 to pivot it to another angle. In some embodiments, the foldable connection 114 may be designed to cause a slight retaining force to be applied to the canister by the retaining tabs 110.

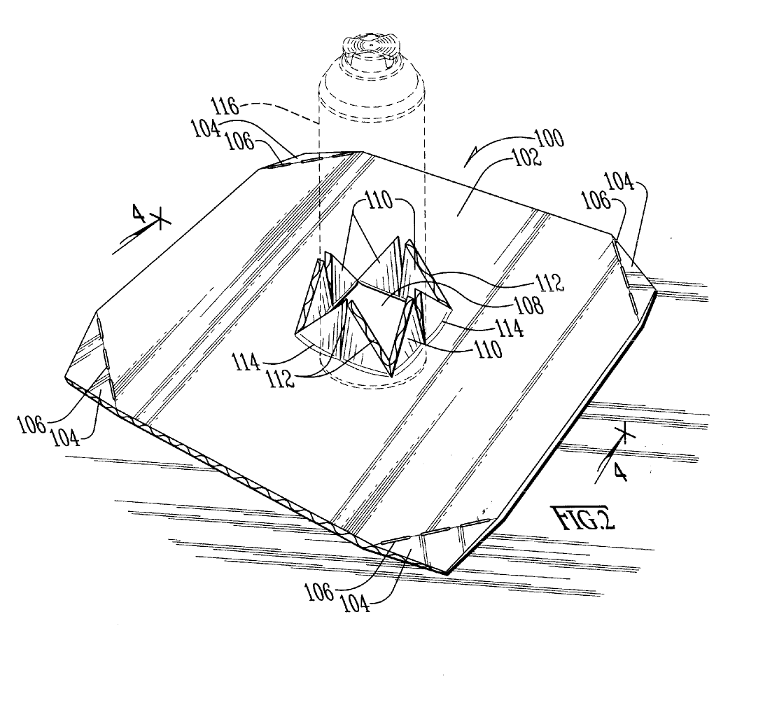

In the depicted embodiment the intersection of the slits 122 locates the approximate center of the opening 108. In the depicted embodiment the retaining tabs 110 are defined by the slits 122 and by seam 114. In other embodiments, the retaining tabs 110 may be defined by the edge of the opening 108 and seams 114. In the depicted embodiment, the seam 114 comprises a scoring of the bottom surface of base 102 as shown on FIG. 2. In other embodiments, seam 114 may be a series of perforations, hinge element, or a preformed fold line to allow the tabs 110 to pivot upwardly or downwardly away from the flat, storage position.

In the depicted embodiment the opening 108 is approximately centered on base 102. In other embodiments, the opening 108 for receiving the canister may be disposed away from the center of base 102 as necessary for a specific application or as otherwise desired.

In some embodiments, the top surface, or other surfaces as well, of base 102 may be coated with a moisture resistant coating to protect the canister stand 100 during use. As the canister dispenses a mist, fog, or spray during use, some of the moisture from the canister may drip down the side of canister or be deposited from airborne particles onto the stand 100. Some of the materials used to form the stand 100 may be susceptible to damage from exposure to moisture. The moisture resistant coating, if present, preserves the structural integrity of the stand 100 in typical use conditions so that the stand 100 may be used multiple times with different canisters.

Referring now to FIG. 2, a perspective view of an embodiment of the canister stand is depicted in a deployed configuration. The base supports 104 are shown pivoted along seams 106 into a downward, deployed position. The stand 100 is shown on a surface, with base 102 supported above the surface, supported by base supports 104 acting as legs.

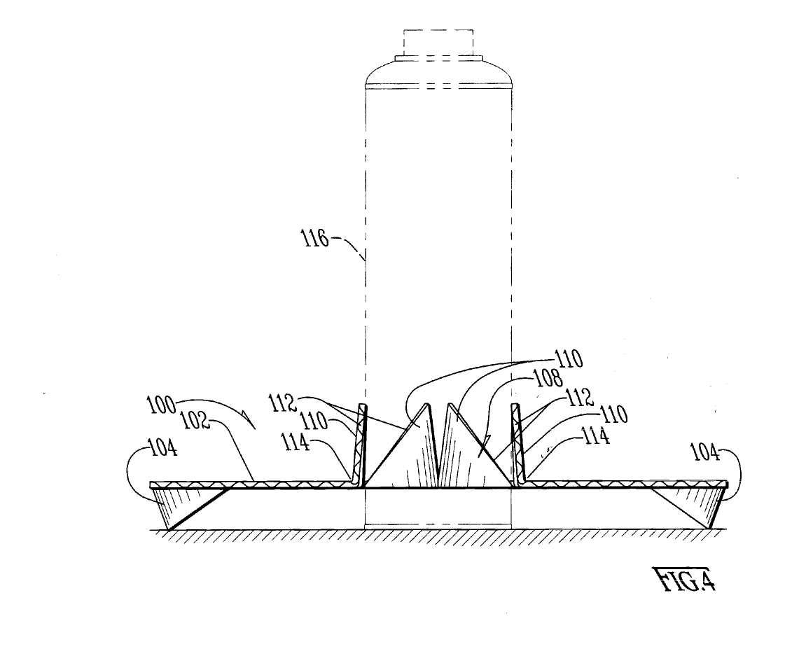

Referring now to FIG. 4, a cross-sectional view of an embodiment of the canister stand is depicted with a canister in dashed lines. The cross-sectional view depicts the section 4-4 shown in FIG. 2. In both FIGS. 2 and 4, the base 102 is supported above a surface by base supports 104 deployed in a downward position. Tabs 110 have been folded upward along seam 114 to create opening 108. A canister 116 is disposed in the opening 108 with tabs 110 in contact with the side of canister 116. In a typical use of the stand 100, substantially all of the weight of canister 116 is supported by the surface, not by stand 100. Stand 100 provides a wide base to prevent the canister 116 from tipping over during use. In some embodiments of the stand 100 it may be configured to support some or all of the weight of the canister during use.

While being supported by the canister stand 100, acceleration of the canister caused by the movement of the supporting surface will be resisted by the wide stance of the base 100, thus reducing the likelihood of the canister tipping over onto its side during use.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and sub-combinations are of utility and may be employed without reference to other features and sub-combinations and are contemplated within the scope of the claims. Not all steps listed in the various figures need be carried out in the specific order described.

1. A canister stand for use with a canister, the canister stand comprising:
a base having a substantially planar portion;
an opening in the base for receiving a canister;
at least one base support formed from a portion of the base and attached to the base by a foldable connection that allows the at least one base support to be pivoted from a storage configuration to a deployed configuration;
at least one retaining tab formed from a portion of the base and attached to the base by a foldable connection that allows the at least one retaining tab to be pivoted from a storage configuration to a deployed configuration;
wherein when the at least one retaining tab is in the deployed configuration a canister may be inserted into and retained in the opening; and
wherein the base is supported by the at least one base support in the deployed configuration.

2. The canister stand of claim 1 wherein the at least one base support comprises a portion of the base defined by the edge of the base and the foldable connection.

3. The canister stand of claim 2 wherein the foldable connection comprises a series of perforations through the base.

4. The canister stand of claim 3 wherein the base is provided with four corners, each corner comprising one of the at least one base supports.

5. The canister stand of claim 2 wherein the opening for receiving a canister comprises two perpendicular, intersecting slits through the base.

6. The canister stand of claim 2 wherein the opening for receiving a canister comprises four intersecting slits offset from each the adjacent slit by 45 degrees.

7. The canister stand of claim 5 wherein the foldable connection of each of the at least one retaining tab extends between two adjacent slits.

8. The canister stand of claim 7 wherein each portion of the base disposed between the intersecting slits and the foldable connection thereof comprises one of the at least one retaining tabs.

9. The canister stand of claim 8 wherein the foldable connection of each of the at least one retaining tabs comprises a series of perforations.

10. The canister stand of claim 9 wherein the deployed configuration of the at least one retaining tab disposes each of the at least one retaining tab in an upward direction from the base.

11. The canister stand of claim 10 wherein the deployed configuration of the at least one base support dispose each of the at least one base support in a downward direction from the base.

12. A canister stand for use with a cylindrical canister containing a solution, the canister having a first end as a base and a second end provided with a nozzle for dispersing the solution, the canister stand comprising:
a substantially planar base having a polygonal shape defined by the edges of the base;
at least one series of perforations in the base extending from one edge of the base to another edge of the base, each portion of the base disposed between each of the at least one series of perforations and the edges of the base comprising a base support;
an aperture disposed through an interior portion of the base for receiving the canister and holding the canister at a point between the first end and the second end of the canister, wherein the aperture is defined by a plurality of edges of the interior portion of the base;
at least one series of perforations in the base extending from one of the plurality of edges of the aperture to another of the plurality of edges of the aperture, each portion of the base disposed between each of the at least one series of perforations and the interior edges of the base comprising a retaining tab;
wherein each series of perforations provides a foldable connection between the two portions of the base disposed on opposed sides thereof.

13. The canister stand of claim 12 wherein the canister stand is in a storage configuration when each of the base supports and each of the retaining tabs are disposed substantially in the same plane as the other portions of the base.

14. The canister stand of claim 13 wherein the canister stand is in a deployed configuration when each of the base supports and each of the retaining tabs are disposed at an angle to the other portions of the base.

15. The canister stand of claim 12 wherein the aperture is defined by four intersecting slits through the base, each slit rotated 45 degrees from the adjacent slits.

16. The canister stand of claim 15 wherein each of the base supports includes a corner of the base.

17. The canister stand of claim 15 wherein when a canister is disposed in the aperture, each of the retaining tabs are in contact with the canister.

18. The canister stand of claim 17 wherein when a canister is disposed on a surface in the canister stand, the second end of the canister is in contact with the surface and each of the base supports are also in contact with the surface.

19. The canister stand of claim 18 wherein the base is coated with a moisture resistant coating

20. The canister stand of claim 14 wherein each of the base supports and each of the retaining tabs may be returned to the storage configuration when the canister stand is not in use.
